(19) United States
(12) Patent Application Publication
(10) Pub. No.: US 2023/0034352 A1
(43) Pub. Date: Feb. 2, 2023

(54) SYSTEMS, METHODS, AND MEDIA FOR PROVIDING ENVIRONMENT INFORMATION TO VISUALLY IMPAIRED PERSONS

(71) Applicant: The Trustees of Columbia University in the City of New York, New York, NY (US)

(72) Inventors: Vishnu Nair, Rego Park, NY (US); Brian Anthony Smith, New York, NY (US)

(21) Appl. No.: 17/876,336

(22) Filed: Jul. 28, 2022

Related U.S. Application Data
(60) Provisional application No. 63/227,175, filed on Jul. 29, 2021.

(51) Int. Cl. A61H 3/06; G09B 21/00; G06V 20/20

(52) U.S. Cl. CPC A61H 3/061; G06V 20/20; G09B 21/008

(57) ABSTRACT

Mechanisms for providing environment information to a visually impaired person (VIP) are provided, the mechanisms including: receiving information relating to a direction from a VIP when in an environment using at least one hardware processor; identifying at least one object in the direction from the VIP when in the environment; and providing environment information regarding at least one object to the VIP. In some of these embodiments, the environment is a virtual environment. In some of these embodiments, the information relating to the direction is a bearing relative to a reference from the VIP. In some of these embodiments, the information is image data. In some of these embodiments, the method further comprises: determining that the direction has changed; and stopping providing the environment information in response to determining that the direction has changed.

### CROSS-REFERENCE TO RELATED APPLICATION

This application claims the benefit of United States Provisional Patent Application No. 63/227,175, filed Jul. 29, 2021, which is hereby explicitly incorporated by reference herein in its entirety.

### BACKGROUND

Visually impaired persons (VIPs) naturally have difficult identifying objects in virtual and real-world environments due to their inability to see.

Accordingly, it is desirable to provide environment information to VIPs.

### SUMMARY

In accordance with embodiment some embodiments, systems, methods, and media for providing environment information to visually impaired persons are provided.

In some embodiments, as part of a computer game, a VIP can use any suitable user input device, such as a game controller, to select a direction for which environment information corresponding to one or more objects in the selected direction of the computer game’s environment from the user’s position in the environment can be provided. In some embodiments, the direction can be selected in any suitable manner, such as using a game controller, orienting the user’s head, orienting the user’s hand, orienting the user' body, speaking a direction (e.g., in degrees, in positions of compass (e.g., North, South, East, West), in positions of an analog clock (e.g., 12 o’clock, 1:30, etc.)). A user device and/or a server can then receive data corresponding to the selected direction, generate a query for objects in the environment in the selected direction from the user’s position in the environment, receive one or more responses to the query, and provide any suitable environment information to the user in any suitable manner as described above, in some embodiments.

In some embodiments, as part of a navigation aid in a real-world environment, a VIP can point a camera in a direction in any suitable manner (such as by rotating the user’s head to which the camera is physically coupled, by orienting a cane to which the camera is physically coupled, by orienting a smart watch into which a camera is integrated, etc.) for which environment information based on one or more images captured by the camera can be provided. A user device and/or a server can then receive image data, perform object recognition using the image data, and provide any suitable environment information to the user based on one or more objects detected in the image data in any suitable manner as described above, in some embodiments. In some embodiments, the image data can be part of video data generated by the camera. In some embodiments, any other suitable data, such as range data, size data, and/or density data provided by any suitable device (such as an optical (e.g., laser) or acoustic sensor) can supplement or supplant the image data. In some embodiments, object recognition can be performed in any suitable manner such as using any suitable machine learning mechanism.

In some embodiments, as part of a navigation aid in a documented real-world environment process, a VIP can use any suitable user input device, such as a cane, the VIP’s head, or with the VIP’s hand with any suitable directional sensor, to select a direction for which environment information corresponding to one or more objects in the selected direction of the environment from the user’s position in the environment can be provided. In some embodiments, the direction can be selected in any suitable manner, such as orienting a cane, orienting the user’s head, orienting the user’s hand, orienting the user' body, speaking a direction (e.g., in degrees, in positions of compass (e.g., North, South, East, West), in positions of an analog clock (e.g., 12 o’clock, 1:30, etc.)). A user device and/or a server can then receive data corresponding to the selected direction, generate a query for objects in the environment in the selected direction from the user’s position in the environment, receive one or more responses to the query, and provide any suitable environment information to the user in any suitable manner as described above, in some embodiments.

In some embodiments, systems for providing environment information to a visually impaired person (VIP) are provided, the systems comprising: memory; and at least one hardware processor collectively configured at least to: receive information relating to a direction from a VIP when in an environment; identify at least one object in the direction from the VIP when in the environment; and provide environment information regarding at least one object to the VIP. In some of these embodiments, the environment is a virtual environment. In some of these embodiments, the information relating to the direction is a bearing relative to a reference from the VIP. In some of these embodiments, the information is image data. In some of these embodiments, the at least one hardware processor is also collectively configured to: determine that the direction has changed; and stop providing the environment information in response to determining that the direction has changed. In some of these embodiments, when identifying the at least one object in the direction, the at least one hard processor is collectively configured at least to perform a database query. In some of these embodiments, when identifying the at least one object in the direction, the at least one hard processor is collectively configured at least to perform a raycast.

In some embodiments, methods for providing environment information to a visually impaired person (VIP) are provided, the methods comprising: receiving information relating to a direction from a VIP when in an environment using at least one hardware processor; identifying at least one object in the direction from the VIP when in the environment; and providing environment information regarding at least one object to the VIP. In some of these embodiments, the environment is a virtual environment. In some of these embodiments, the information relating to the direction is a bearing relative to a reference from the VIP. In some of these embodiments, the information is image data. In some of these embodiments, the method further comprises: determining that the direction has changed; and stopping providing the environment information in response to determining that the direction has changed. In some of these embodiments, identifying the at least one object in the direction comprises performing a database query. In some of these embodiments, identifying the at least one object in the direction comprises performing a raycast.

In some embodiments, non-transitory computer-readable media containing computer executable instructions that, when executed by a processor, cause the processor to perform a method for providing environment information to a visually impaired person (VIP) are provided, the method comprising: receiving information relating to a direction from a VIP when in an environment using at least one hardware processor; identifying at least one object in the direction from the VIP when in the environment; and providing environment information regarding at least one object to the VIP. In some of these embodiments, the environment is a virtual environment. In some of these embodiments, the information relating to the direction is a bearing relative to a reference from the VIP. In some of these embodiments, the information is image data. In some of these embodiments, the method further comprises: determining that the direction has changed; and stopping providing the environment information in response to determining that the direction has changed. In some of these embodiments, identifying the at least one object in the direction comprises performing a database query. In some of these embodiments, identifying the at least one object in the direction comprises performing a raycast.

### BRIEF DESCRIPTION OF THE DRAWINGS

FIG. 1 is an example block diagram of a system that can be used in accordance with some embodiments.

FIG. 2 is an example of a block diagram of hardware that can be used to implement a user device, a server, and/or a database in accordance with some embodiments.

FIG. 3 is an example of a process for providing environment information to a visually impaired person (VIP) when in a virtual environment (e.g., when playing a computer game) in accordance with some embodiments.

FIG. 4 is an example of a process for providing environment information to a VIP when in a real-world environment in accordance with some embodiments.

FIG. 5 is an example of a process for providing environment information to a VIP when is navigating a documented real-world environment in accordance with some embodiments.

### DETAILED DESCRIPTION

In accordance with some embodiments, systems, methods, and media for providing environment information to visually impaired persons (VIPs) are provided. Any suitable environment information can be provided in some embodiments. For example, in some embodiments, environment information can be provided regarding one or more objects in an area around a user in a game, a virtual environment, or the real world.

In some embodiments, any suitable thing can be an object, any suitable information regarding the object can be included in the environment information for the object, and the environment information for the object can be provided in any suitable manner. For example, in some embodiments, an object can be a person, an animal, a plant, a geological formation, a body of water, a machine, a manufactured item, the environment itself (such as a wall, a cliff/ledge a corner, etc.) and/or any other suitable thing. As another example, in some embodiments, the environment information can include an identifier of a type of the object, an identifier of the specific object, an identifier of a characteristic of the object (e.g., size (e.g., area from users perspective, volume, height, width, etc.), elevation, range, color, pattern, temperature, odor, texture, activity, speed, velocity, location relative to one or more other objects, and/or any other suitable characteristic of the object), and/or any other suitable information regarding an object. As still another example, in some embodiments, the environment information can be provided using audible words, sounds, haptic feedback, odors, flavors, temperatures, and/or any other suitable mechanism for conveying information As yet another example, in some embodiments, environment information regarding an object can simply identify the object or type of object (e.g., a person) and/or it can identify the object in the context of things around it (e.g., a tall person holding a gun behind a bush). Any suitable level of detail can be provided in some embodiments.

In some embodiments, as part of a computer game, a VIP can use any suitable user input device, such as a game controller, to select a direction for which environment information corresponding to one or more objects in the selected direction of the computer game’s environment from the user’s position in the environment can be provided. In some embodiments, the direction can be selected in any suitable manner, such as using a game controller, orienting the user’s head, orienting the user’s hand, orienting the user' body, speaking a direction (e.g., in degrees, in positions of compass (e.g., North, South, East, West), in positions of an analog clock (e.g., 12 o’clock, 1:30, etc.)). A user device and/or a server can then receive data corresponding to the selected direction, generate a query for objects in the environment in the selected direction from the user’s position in the environment, receive one or more responses to the query, and provide any suitable environment information to the user in any suitable manner as described above, in some embodiments.

In some embodiments, as part of a navigation aid in a real-world environment, a VIP can point a camera in a direction in any suitable manner (such as by rotating the user’s head to which the camera is physically coupled, by orienting a cane to which the camera is physically coupled, by orienting a smart watch into which a camera is integrated, etc.) for which environment information based on one or more images captured by the camera can be provided. A user device and/or a server can then receive image data, perform object recognition using the image data, and provide any suitable environment information to the user based on one or more objects detected in the image data in any suitable manner as described above, in some embodiments. In some embodiments, the image data can be part of video data generated by the camera. In some embodiments, any other suitable data, such as range data, size data, and/or density data provided by any suitable device (such as an optical (e.g., laser) or acoustic sensor) can supplement or supplant the image data. In some embodiments, object recognition can be performed in any suitable manner such as using any suitable machine learning mechanism.

In some embodiments, as part of a navigation aid in a documented real-world environment process, a VIP can use any suitable user input device, such as a cane, the VIP’s head, or with the VIP’s hand with any suitable directional sensor, to select a direction for which environment information corresponding to one or more objects in the selected direction of the environment from the user’s position in the environment can be provided. In some embodiments, the direction can be selected in any suitable manner, such as orienting a cane, orienting the user’s head, orienting the user’s hand, orienting the user' body, speaking a direction (e.g., in degrees, in positions of compass (e.g., North, South, East, West), in positions of an analog clock (e.g., 12 o’clock, 1:30, etc.)). A user device and/or a server can then receive data corresponding to the selected direction, generate a query for objects in the environment in the selected direction from the user’s position in the environment, receive one or more responses to the query, and provide any suitable environment information to the user in any suitable manner as described above, in some embodiments.

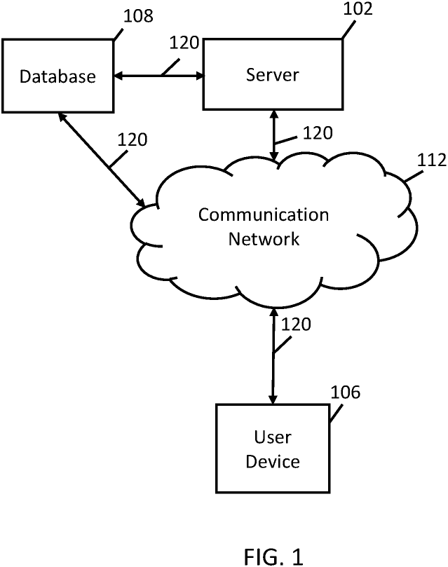

Turning to FIG. 1, an example 100 of hardware that can be used in accordance with some embodiments of the disclosed subject matter is shown. As illustrated, hardware 100 can include a server 102, a user device 106, a database 108, and a communication network 112.

Although particular numbers of particular devices are illustrated in FIG. 1, any suitable number(s) of each device shown, and any suitable additional or alternative devices, can be used in some embodiments. For example, one or more additional devices, such as servers, computers, routers, networks, etc., can be included in some embodiments. As another example, in some embodiments, any two or more of devices 102, 106, and 108 can be combined. As yet another example, in some embodiments, devices 102 and 108 can be omitted and some of the functionality described as being provided thereby can be implemented in user device 106.

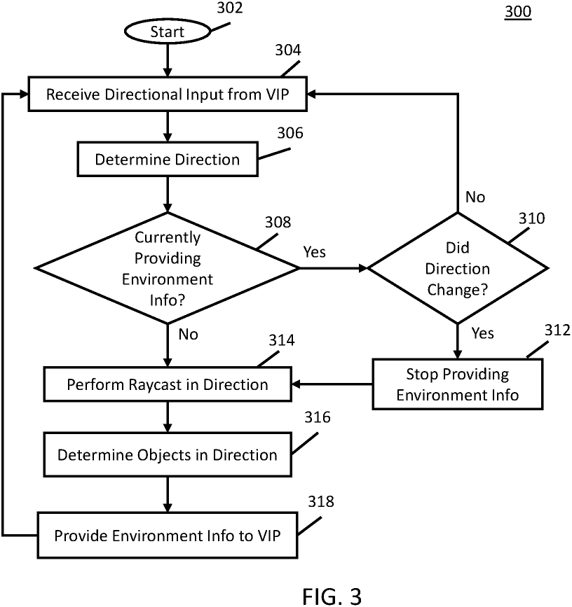

Server 102 can be any suitable device for providing a game, providing environment information, and/or performing any other suitable function(s), such as those further described below in connection with the processes of FIGS. 3-5.

User device 106 can be any suitable device for providing a game, providing environment information, and/or performing any other suitable function in some embodiments. For example, in some embodiments, user device 106 can be a smart phone and/or smart watch, a laptop computer, a desktop computer, a tablet computer, a smart speaker, a smart display, a smart appliance, a navigation system, a smart cane, and/or any other suitable device capable of receiving directional input from a user and providing a game and/or environment information to a user.

Database 108 can be any suitable database running on any suitable hardware in some embodiments. For example, database 108 can run a MICROSOFT SQL database available from MICROSOFT CORP. of Redmond, Washington.

Communication network 112 can be any suitable combination of one or more wired and/or wireless networks in some embodiments. For example, in some embodiments, communication network 112 can include any one or more of the Internet, a mobile data network, a satellite network, a local area network, a wide area network, a telephone network, a cable television network, a WiFi network, a WiMax network, and/or any other suitable communication network.

Server 102, user device 106, and database 108 can be connected by one or more communications links 120 to each other and/or to communication network 112. These communications links can be any communications links suitable for communicating data among server 102, user device 106, database 108, and communication network 112, such as network links, dial-up links, wireless links, hard-wired links, routers, switches, any other suitable communications links, or any suitable combination of such links.

In some embodiments, communication network 112 and the devices connected to it can form or be part of a wide area network (WAN) or a local area network (LAN).

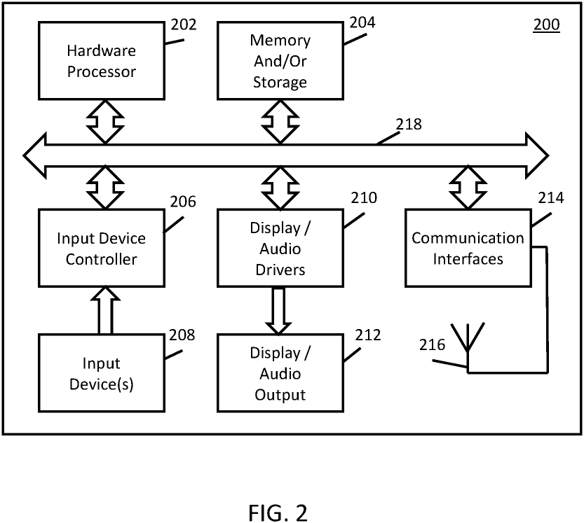

Server 102, user device 106, and/or database 108 can be implemented using any suitable hardware in some embodiments. For example, in some embodiments, server 102, user device 106, and/or database 108 can be implemented using any suitable general-purpose computer or special-purpose computer(s). For example, user device 106 can be implemented using a special-purpose computer, such as a smart phone and/or a smart watch. Any such general-purpose computer or special-purpose computer can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 204 can be any suitable memory and/or storage for storing programs, data, and/or any other suitable information in some embodiments. For example, memory and/or storage 204 can include random access memory, read-only memory, flash memory, hard disk storage, solid-state drive, optical media, and/or any other suitable memory.

Input device controller 206 can be any suitable circuitry for controlling and receiving input from input device(s) 208, in some embodiments. For example, input device controller 206 can be circuitry for receiving input from an input device 208, such as a touch screen, one or more buttons, a voice recognition circuit, a microphone, a camera, an optical sensor, an accelerometer, a temperature sensor, a near field sensor, a game controller, a global positioning system (GPS) receiver, a direction sensor (e.g., an electronic compass), an attitude sensor, a gyroscope, and/or any other type of input device.

Display/audio drivers 210 can be any suitable circuitry for controlling and driving output to one or more display/audio output circuitries 212 in some embodiments. For example, display/audio drivers 210 can be circuitry for driving one or more display/audio output circuitries 212, such as an LCD display, a speaker, an LED, or any other type of output device.

Communication interface(s) 214 can be any suitable circuitry for interfacing with one or more communication networks, such as network 112 as shown in FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network in some embodiments. In some embodiments, antenna 216 can be omitted when not needed.

Bus 218 can be any suitable mechanism for communicating between two or more components 202, 204, 206, 210, and 214 in some embodiments.

Any other suitable components can additionally or alternatively be included in hardware 200 in accordance with some embodiments.

Turning to FIG. 3, an example 300 of a process for providing environment information to a VIP when in a virtual environment (e.g., when playing a computer game) in accordance with some embodiments is illustrated.

As illustrated, after process 300 begins at 302, the process receives directional input from a VIP at 304. This directional input can be provided in any suitable manner such as by the VIP using a game controller’s thumbstick to select a direction or by orienting the VIP’s head so that a sensor coupled to the head detects a change in direction.

Next, at 306, process 300 can determine a direction from a VIP’s position based on the directional input. This determination can be made in any suitable manner in some embodiments. For example, in some embodiments, if a thumbstick is pushed straight up (e.g., at 12 o’clock), the direction can be considered to be forward from whichever direction the VIP’s character is facing in the game. As another example, in some embodiments, if a thumbstick is pushed straight down (e.g., at 6 o’clock), the direction can be considered to be backward from whichever direction the VIP’s character is facing in the game (backward). As yet another example, in some embodiments, if a thumbstick is pushed left (e.g., at 9 o’clock), the direction can be considered to be left from whichever direction the VIP’s character is facing in the game. As still another example, in some embodiments, if a thumbstick is pushed right (e.g., at 3 o’clock), the direction can be considered to be right from whichever direction the VIP’s character is facing in the game. As still another example, in some embodiments, if a game controller is tilted back (as detected by an accelerometer or gyroscope in the game controller, for example), the direction can be considered to be upward from the horizon of the VIP’s character in the game. As yet another example, in some embodiments, if a game controller is tilted forward (as detected by an accelerometer or gyroscope in the game controller, for example), the direction can be considered to be downward from the horizon of the VIP’s character in the game. Any suitable intermediate and/or continuous values between these can be enabled in some embodiments.

Any suitable direction can be determined in some embodiments. For example, bearing information (e.g., 0-360 degrees) that is relative to some reference can be determined in some embodiments. As another example, additionally or alternatively, attitude information (e.g., up/down angle) that is relative to a horizontal plane or some other reference can be determined in some embodiments.

Note that, in some embodiments, the VIP’s character’s orientation is not changed by the directional input. In some embodiments, the VIP can change the character’s orientation using another directional input (e.g., another thumbstick).

Then, at 308, process 300 can determine if it is currently providing environment information as described below in connection with 318. If so, at 310, process 300 can then determine if the direction determined changed from the direction corresponding to the environment information currently being provided. In some embodiments, determining that the direction changed can include determining that the direction changed by more than a threshold amount and not counting as a direction change changes that are smaller than the threshold amount. If it is determined at 310 that the direction did not change, process 300 can loop back to 304. Otherwise, if it is determined at 310 that the direction did change, process 300 can stop providing environment information corresponding to the previous direction at 312.

After stopping providing environment information at 312 or after determining at 308 that environment information is not currently being provided, process 300 can at 314 perform a raycast emanating from the VIP’s character’s position in the game outward in the determined direction. The raycast can be performed in any suitable manner in some embodiments.

At 316, process 300 can next determine one or more objects along the raycast. Any suitable number (including zero) of objects can be determined in any suitable manner in some embodiments. For example, in some embodiments, only the single closest object along the raycast can be determined. As another example, in some embodiments, all objects within a given range of the VIP’s character can be determined.

Next, at 318, process 300 can provide environment information for one or more of the object(s) determined at 316. This environment information can be provided in any suitable manner as described above. For example, in some embodiments, environment information can be provided as an audible word followed by a tone that is played as long as the direction is maintained on a corresponding object. In some embodiments, when no object is found at a particular direction, a tone (or any other suitable indicator) corresponding to that condition can be played to alert the user than no object is in that direction. In some embodiments, when an occlusion (e.g., a wall) is present at a particular direction a tone (or any other suitable indicator) corresponding to that condition can be played to alert the user than an occlusion is in that direction. In some embodiments, any suitable details (e.g., height, width, density, type, etc.) regarding an occlusion can be indicated in some embodiments.

In some embodiments, when more than one object is present in a minimum angular width and/or height at a given direction, environment information for each of those objects can be presented to a user in the manner described above. Should the user move forward in that direction one or more of those objects may fall out of that minimum angular width and/or height and therefore not be included in the environment information presented for that direction. Likewise, should the user move backward in that direction additional objects may fall into that minimum angular width and/or height and therefore be included in the environment information presented for that direction.

Then, process 300 can loop back to 304 to receive the next directional input from the VIP.

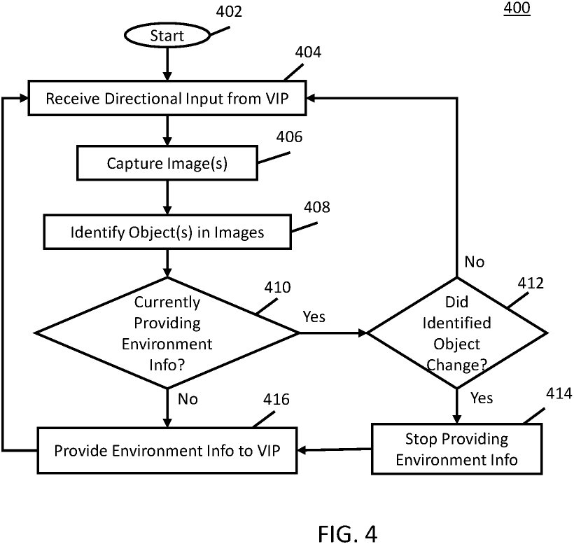

Turning to FIG. 4, an example 400 of a process for providing environment information to a VIP when in a real-world environment in accordance with some embodiments is illustrated.

As illustrated, after process 400 begins at 402, the process receives directional input from a VIP at 404. This directional input can be provided in any suitable manner such as by the VIP orienting a cane or the VIP’s head to which a camera is attached, or a smart watch incorporating a camera, in a given direction.

Next, at 406, process 400 can capture one or more images using the camera. Any suitable number of images can be captured, those images can have any suitable characteristics (total number of pixels, pixel density, colors (e.g., black and white, gray scale, color), etc.), and the images can be part of video, in some embodiments.

Then, at 408, process 400 can identify object(s) (e.g., a traffic light at a particular address), type(s) of object(s) (e.g., a traffic light), content(s) of object(s) (e.g., that the traffic light is red) in the images in any suitable manner. For example, in some embodiments, object(s), object types, and/or object content can be identified using any suitable machine learning mechanism trained using any suitable training images.

Next, at 410, process 400 can determine if it is currently providing environment information as described below in connection with 416. If so, at 412, process 400 can then determine if the identified object(s) (or content of the object(s) if applicable) changed from the identified object(s) (or content of the object(s) if applicable) corresponding to the environment information currently being provided. If it is determined at 412 that the identified object(s) (or content of the object(s) if applicable) did not change, process 400 can loop back to 404. Otherwise, if it is determined at 412 that the identified object(s) (or content of the object(s) if applicable) did change, process 400 can stop providing environment information corresponding to the previous identified object(s) (or previous content of the object(s) if applicable) at 414.

After stopping providing environment information at 414 or after determining at 410 that environment information is not currently being provided, process 400 can at 416 provide environment information for one or more of the object(s) determined at 408. This environment information can be provided in any suitable manner as described above. For example, in some embodiments, environment information can be provided as an audible word followed by a tone that is played as long as the direction is maintained on a corresponding object. In some embodiments, when no object is found at a particular direction, a tone (or any other suitable indicator) corresponding to that condition can be played to alert the user than no object is in that direction. In some embodiments, when an occlusion is present at a particular direction a tone (or any other suitable indicator) corresponding to that condition can be played to alert the user than an occlusion is in that direction. In some embodiments, any suitable details (e.g., height, width, density, type, etc.) regarding an occlusion can be indicated in some embodiments.

In some embodiments, when more than one object is present in a minimum angular width and/or height at a given direction, environment information for each of those objects can be presented to a user in the manner described above. Should the user move forward in that direction one or more of those objects may fall out of that minimum angular width and/or height and therefore not be included in the environment information presented for that direction. Likewise, should the user move backward in that direction additional objects may fall into that minimum angular width and/or height and therefore be included in the environment information presented for that direction.

Then, process 400 can loop back to 404 to receive the next directional input from the VIP.

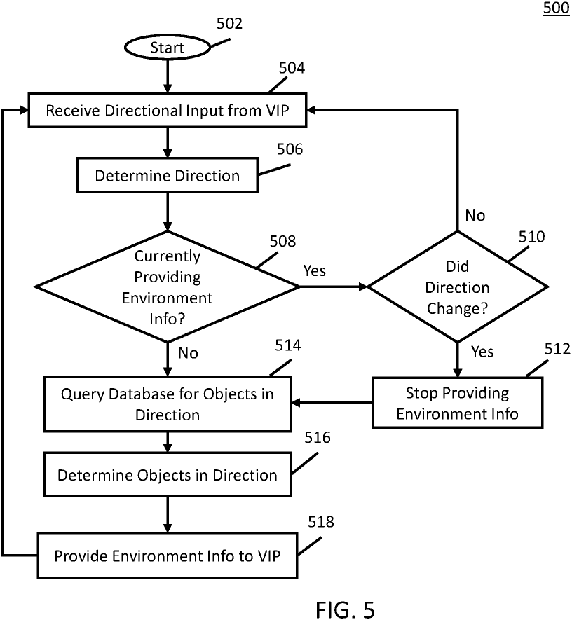

Turning to FIG. 5, an example 500 of a process for providing environment information to a VIP when is navigating a documented real-world environment in accordance with some embodiments is illustrated.

As illustrated, after process 500 begins at 502, the process receives directional input from a VIP at 504. This directional input can be provided in any suitable manner such as by the VIP orienting a cane, the VIP’s head, or with the VIP’s hand with any suitable directional sensor to a given direction.

Next, at 506, process 500 can determine a direction from a VIP’s position based on the directional input. This determination can be made in any suitable manner in some embodiments.

Any suitable direction can be determined in some embodiments. For example, bearing information (e.g., 0-360 degrees) that is relative to some reference can be determined in some embodiments. As another example, additionally or alternatively, attitude information (e.g., up/down angle) that is relative to a horizontal plane or some other reference can be determined in some embodiments.

Then, at 508, process 500 can determine if it is currently providing environment information as described below in connection with 518. If so, at 510, process 500 can then determine if the direction determined changed from the direction corresponding to the environment information currently being provided. In some embodiments, determining that the direction changed can include determining that the direction changed by more than a threshold amount and not counting as a direction change changes that are smaller than the threshold amount. If it is determined at 510 that the direction did not change, process 500 can loop back to 504. Otherwise, if it is determined at 510 that the direction did change, process 500 can stop providing environment information corresponding to the previous direction at 512.

After stopping providing environment information at 512 or after determining at 508 that environment information is not currently being provided, process 500 can at 514 perform a database query for objects in the determined direction. Any suitable database and any suitable database query technique can be used in some embodiments.

At 516, process 500 can next determine one or more objects based on the query results. Any suitable number (including zero) of objects can be determined in any suitable manner in some embodiments. For example, in some embodiments, only the single closest object to the VIP in the direction can be determined. As another example, in some embodiments, all objects within a given range of the VIP can be determined.

Next, at 518, process 500 can provide environment information for one or more of the object(s) determined at 516. This environment information can be provided in any suitable manner as described above. For example, in some embodiments, environment information can be provided as an audible word followed by a tone that is played as long as the direction is maintained on a corresponding object. In some embodiments, when no object is found at a particular direction, a tone (or any other suitable indicator) corresponding to that condition can be played to alert the user than no object is in that direction. In some embodiments, when an occlusion is present at a particular direction a tone (or any other suitable indicator) corresponding to that condition can be played to alert the user than an occlusion is in that direction. In some embodiments, any suitable details (e.g., height, width, density, type, etc.) regarding an occlusion can be indicated in some embodiments.

In some embodiments, when more than one object is present in a minimum angular width and/or height at a given direction, environment information for each of those objects can be presented to a user in the manner described above. Should the user move forward in that direction one or more of those objects may fall out of that minimum angular width and/or height and therefore not be included in the environment information presented for that direction. Likewise, should the user move backward in that direction additional objects may fall into that minimum angular width and/or height and therefore be included in the environment information presented for that direction.

Then, process 500 can loop back to 504 to receive the next directional input from the VIP.

It should be understood that at least some of the above-described blocks of the processes of FIGS. 3, 4, and 5 can be executed or performed in any order or sequence not limited to the order and sequence shown in and described in the figures. Also, some of the above blocks of the processes of FIGS. 3, 4, and 5 can be executed or performed substantially simultaneously where appropriate or in parallel to reduce latency and processing times. Additionally or alternatively, some of the above described blocks of the processes of FIGS. 3, 4, and 5 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

As described above, embodiments presented herein enable VIPs to interactively receive information in virtual environments (e.g., games) as well as real-world environments. A VIP can select a direction and receive information on one or more objects at that direction. This provides the VIP with autonomy when in these environments.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A system for providing environment information to a visually impaired person (VIP), comprising:
memory; and
at least one hardware processor collectively configured at least to:
receive information relating to a direction from a VIP when in an environment;
identify at least one object in the direction from the VIP when in the environment; and
provide environment information regarding at least one object to the VIP.

2. The system of claim 1, wherein the environment is a virtual environment.

3. The system of claim 1, wherein the information relating to the direction is a bearing relative to a reference from the VIP.

4. The system of claim 1, wherein the information is image data.

5. The system of claim 1, wherein the at least one hardware processor is also collectively configured to:
determine that the direction has changed; and
stop providing the environment information in response to determining that the direction has changed.

6. The system of claim 1, wherein when identifying the at least one object in the direction, the at least one hard processor is collectively configured at least to perform a database query.

7. The system of claim 1, wherein when identifying the at least one object in the direction, the at least one hard processor is collectively configured at least to perform a raycast.

8. A method for providing environment information to a visually impaired person (VIP), comprising:
receiving information relating to a direction from a VIP when in an environment using at least one hardware processor;
identifying at least one object in the direction from the VIP when in the environment; and
providing environment information regarding at least one object to the VIP.

9. The method of claim 8, wherein the environment is a virtual environment.

10. The method of claim 8, wherein the information relating to the direction is a bearing relative to a reference from the VIP.

11. The method of claim 8, wherein the information is image data.

12. The method of claim 8, further comprising:
determining that the direction has changed; and
stopping providing the environment information in response to determining that the direction has changed.

13. The method of claim 8, wherein identifying the at least one object in the direction comprises performing a database query.

14. The method of claim 8, wherein identifying the at least one object in the direction comprises performing a raycast.

15. A non-transitory computer-readable medium containing computer executable instructions that, when executed by a processor, cause the processor to perform a method for providing environment information to a visually impaired person (VIP), the method comprising:
receiving information relating to a direction from a VIP when in an environment using at least one hardware processor;
identifying at least one object in the direction from the VIP when in the environment; and
providing environment information regarding at least one object to the VIP.

16. The non-transitory computer-readable medium of claim 15, wherein the environment is a virtual environment.

17. The non-transitory computer-readable medium of claim 15, wherein the information relating to the direction is a bearing relative to a reference from the VIP.

18. The non-transitory computer-readable medium of claim 15, wherein the information is image data.

19. The non-transitory computer-readable medium of claim 15, wherein the method further comprises:
determining that the direction has changed; and
stopping providing the environment information in response to determining that the direction has changed.

20. The non-transitory computer-readable medium of claim 15, wherein identifying the at least one object in the direction comprises performing a database query.

21. The non-transitory computer-readable medium of claim 15, wherein identifying the at least one object in the direction comprises performing a raycast.
